(19) United States
(12) Patent Application Publication
(10) Pub. No.: US 2012/0272644 A1
(43) Pub. Date: Nov. 1, 2012

(54) APPARATUS AND METHOD TO CONTROL TURBOCHARGER WASTE GATE DURING ENGINE BRAKING

(75) Inventors: Zdenek S. Meistrick, West Granby, CT (US); Neil E. Fuchs, New Hartford, CT (US); Yan Dong, Cheshire, CT (US)

(73) Assignee: Jacobs Vehicle Systems, Inc., Bloomfield, CT (US)

(21) Appl. No.: 13/457,938

(22) Filed: Apr. 27, 2012

Related U.S. Application Data
(60) Provisional application No. 61/479,682, filed on Apr. 27, 2011.

(51) Int. Cl. F02B 37/18; F02B 37/00

(52) U.S. Cl. 60/602

(57) ABSTRACT

The present invention relates to a methods and apparatus for controlling the actuation of the waste gate of a turbocharger. The waste gate may be opened in response to a pneumatically operated waste gate actuator connected to the intake manifold by a waste gate actuator passage. A waste gate cut-off valve may be disposed in the waste gate actuator passage and may block the waste gate actuator passage in response to an engine braking operation of the engine. Alternatively, a snubber may be disposed in the waste gate actuator passage.

### CROSS REFERENCE TO RELATED APPLICATIONS

The present application relates to, and claims the priority of Provisional Patent Application No. 61/479,682 filed Apr. 27, 2011 and entitled Apparatus and Method to Control Turbocharger Waste Gate During Engine Braking.

### FIELD OF THE INVENTION

The present invention relates generally to the field of turbochargers and engine braking in internal combustion engines. In particular, the present invention relates to a system and method for controlling the actuation of the waste gate of a turbocharger, for example, during engine braking.

### BACKGROUND OF THE INVENTION

The power generated by an internal combustion (I.C.) engine depends, in part, on the air mass and the quantity of fuel that can be fed to the internal combustion engine. The horsepower and torque of an internal combustion engine can be increased by increasing the air mass in the internal combustion engine. It is well known that turbochargers are used to increase the horsepower and torque of an internal combustion engine by pressurizing or boosting the intake air.

A turbocharger may be composed of a compressor and a turbine, which are connected through a common shaft. The compressor may be housed in a compressor housing and the turbine may be housed in a turbine housing. The turbine housing may be separate from the exhaust housing of the turbocharger. The exhaust gas exiting the engine may be routed through the turbine housing of a turbocharger such that it spins the exhaust gas-driven turbine. The rotary action of the turbine may be conveyed through the common shaft to an air compressor mounted on an opposite end of the shaft. Thus, the rotation of the turbine causes the compressor to spin within the compressor housing. The spinning action of the compressor causes the air entering the compressor housing to be pressurized or boosted to a desired level before it is fed into the cylinders of the internal combustion engine. The pressurized or boosted air increases the air mass in the internal combustion engine, and as a result, the internal combustion engine may produce more positive or engine braking power.

As the quantity of pressurized or boosted air within the combustion chamber of the internal combustion engine increases, the exhaust gas coming out of the combustion chamber increases, thereby increasing the rotational speed of the turbine, compressor and the common shaft. The increased speed of the compressor, in turn, further pressurizes or boosts the intake air. If the rotational speed of the rotating parts were allowed to increase with every cycle, the rotating speeds may increase to such a level that the rotating parts may be destroyed. Moreover, the increased pressure due to the compressed air within the combustion chamber of the internal combustion engine may exceed the maximum desired pressure rating of the combustion chamber. Therefore, there is a need to regulate the turbochargers so as to protect the engine from over-boost and the turbocharger from over-speed.

To control the speed of the turbocharger, and hence the amount of pressure imparted to the engine, many turbochargers include a waste gate, which permits a portion of the exhaust gas of the engine to bypass the turbine portion of the turbocharger. By diverting a portion of the exhaust gases around the turbocharger turbine, the rotational speed of the turbine may be reduced, thus reducing the rotational speed of the air compressor, which is connected to the turbine through the common shaft. The reduced rotational speed of the air compressor may reduce the amount by which the intake air is pressurized. Typically, the waste gate may be disposed in the exhaust flow path and be connected to a waste gate actuator for moving the waste gate between open and closed positions. The actuator may move the waste gate between an open and closed position in response to boost pressure. In the open position, some or all of the exhaust gas is diverted around the turbine housing whereas, in the closed position, all of the exhaust gas travels through the turbine housing.

Flow control of exhaust gas through an internal combustion engine may also be used to provide vehicle engine braking. Generally, engine braking systems may control the flow of exhaust gas to incorporate the principles of compression-release type braking, exhaust gas recirculation, exhaust pressure regulation, and/or bleeder type braking. The operation of a compression-release type engine brake, or retarder, is well known. During engine braking, the exhaust valves may be selectively opened to convert, at least temporarily, a power producing internal combustion engine into a power absorbing air compressor. As a piston travels upward during its compression stroke, the gases that are trapped in the cylinder are compressed. The compressed gases oppose the upward motion of the piston. During engine braking operation, as the piston approaches the top dead center (TDC), at least one exhaust valve is opened to release the compressed gases in the cylinder to the exhaust manifold, preventing the energy stored in the compressed gases from being returned to the engine on the subsequent expansion down-stroke. In doing so, the engine develops retarding power to help slow the vehicle down. An example of a prior art compression-release engine brake is provided by the disclosure of the Cummins, U.S. Pat. No. 3,220,392 (November 1965), which is hereby incorporated by reference. A switch that is placed close to the operator of the vehicle may activate the engine braking or compression-release engine brake. The switch that activates the engine braking or compression-release engine brake is generally distinct from and not connected to the friction brake system or the brake pedal of the vehicle.

During all types of engine braking, and particularly compression-release type engine braking, maximum boost pressure is desired to maximize the braking power of the engine. Compression-release type engine braking in particular may create a strong pressure pulse in the exhaust manifold, thereby actuating the waste gate actuator, opening the waste gate valve, and allowing the exhaust gases to bypass the turbine housing. The reduced flow of exhaust gases through the turbine housing may reduce the rotational speed of the turbine and the compressor, thereby reducing the boost pressure that is developed by the compressor. This reduced pressure may result in reduced engine braking power, which is assisted by higher boost pressure. Therefore, it may be desirable to override or deactivate the waste gate actuator to maintain the waste gate in the closed position during compression-release type engine braking. One or more embodiments of the present invention may provide the advantage of controlling the actuation of the waste gate of a turbocharger during engine braking to avoid undesired reduction of boost pressure during engine braking.

### SUMMARY OF THE INVENTION

Responsive to the foregoing challenges, Applicants have developed an innovative turbocharger system comprising: a turbocharger turbine connected by a shaft to a turbocharger compressor, said turbocharger turbine having an inlet side and an outlet side, and said turbocharger compressor having an inlet side and an outlet side; an exhaust manifold connected to the turbocharger turbine inlet side; an intake manifold connected to the turbocharger compressor outlet side; an exhaust bypass line extending between the exhaust manifold and the turbocharger turbine outlet side; a waste gate disposed in the exhaust bypass line; a waste gate actuator for controlling the opening and closing of the waste gate, said waste gate actuator operatively connected to the waste gate; a waste gate actuator passage extending from the turbocharger compressor outlet side to the waste gate actuator; and a means for restricting air flow through the waste gate actuator passage, said means for restricting disposed in the waste gate actuator passage.

Applicants have further developed an innovative turbocharger system comprising: a turbocharger turbine connected by a shaft to a turbocharger compressor, said turbocharger turbine having an inlet side and an outlet side, and said turbocharger compressor having an inlet side and an outlet side; an exhaust manifold connected to the turbocharger turbine inlet side; an intake manifold connected to the turbocharger compressor outlet side; an exhaust bypass line extending between the exhaust manifold and the turbocharger turbine outlet side; a waste gate disposed in the exhaust bypass line; a waste gate actuator for controlling the opening and closing of the waste gate, said waste gate actuator operatively connected to the waste gate; a waste gate actuator passage extending from the turbocharger compressor outlet side to the waste gate actuator; and a waste gate actuator cut-off valve disposed in the waste gate actuator passage.

Applicants have still further developed an innovative turbocharger system comprising: a turbocharger turbine connected by a shaft to a turbocharger compressor, said turbocharger turbine having an inlet side and an outlet side, and said turbocharger compressor having an inlet side and an outlet side; an exhaust manifold connected to the turbocharger turbine inlet side; an intake manifold connected to the turbocharger compressor outlet side; an exhaust bypass line extending between the exhaust manifold and the turbocharger turbine outlet side; a waste gate disposed in the exhaust bypass line; a waste gate actuator for controlling the opening and closing of the waste gate, said waste gate actuator operatively connected to the waste gate; a waste gate actuator passage extending from the turbocharger compressor outlet side to the waste gate actuator; and a snubber disposed in the waste gate actuator passage.

It is to be understood that both the foregoing general description and the following detailed description are exemplary and explanatory only, and are not restrictive of the invention as claimed.

### BRIEF DESCRIPTION OF THE DRAWINGS

In order to assist the understanding of this invention, reference will now be made to the appended drawings, in which like reference characters refer to like elements. The drawings are exemplary only, and should not be construed as limiting the invention.

FIG. 1 is a schematic diagram illustrating the general relationship of the engine components with the turbocharger and the waste gate in known systems.

FIG. 2 is a schematic diagram illustrating a system for controlling the actuation of the waste gate of a turbocharger according to a first embodiment of the invention.

FIG. 3 is a schematic diagram illustrating a system for controlling the actuation of the waste gate of a turbocharger according to a second embodiment of the invention.

### DETAILED DESCRIPTION OF EMBODIMENTS OF THE INVENTION

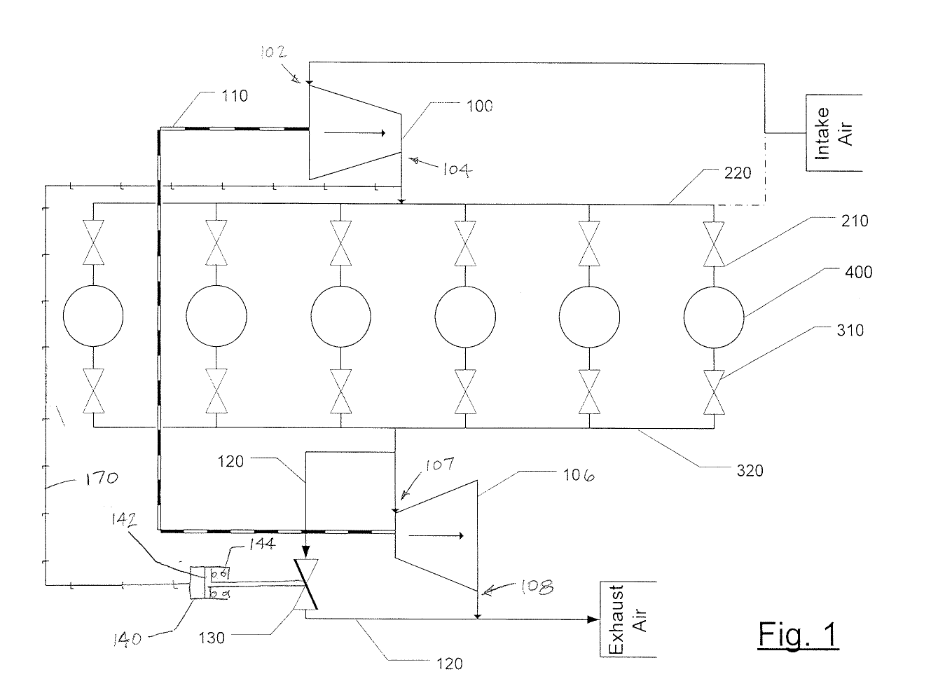

As embodied herein, the present invention relates to a system and method for controlling the actuation of the waste gate of a turbocharger during engine braking. FIG. 1 schematically illustrates an internal engine in which a turbocharger is installed. The engine may have one or more engine cylinders 400, and one or more intake valves 210 and one or more exhaust valves 310, associated with each cylinder. An exhaust manifold 320 may be connected to the cylinders 400 under the control of the exhaust valves 310, and an intake manifold 220 may be connected to the cylinder 400 under the control of the intake valves 210. The exhaust manifold 320 and the intake manifold 220 may comprise a single manifold or a split-manifold.

The turbocharger may comprise a turbine 106 connected to the exhaust manifold 320, and a compressor 100 connected to the intake manifold 220. The turbine 106 and the compressor 100 may be mechanically connected by a common shaft 110, which causes the compressor to rotate when the turbine is rotated. The turbine 106 and the compressor 100 may be housed in a turbine housing having a turbine inlet side 107 a turbine outlet side 108, and a compressor housing having a compressor inlet side 102 and a compressor outlet side 104, respectively. Air or gas flow may pass sequentially from the inlet side 102 of the compressor 100 to the outlet side of the compressor to the intake manifold 220 to the engine cylinders 400 to the exhaust manifold 320 to the turbine inlet side 107 and through the turbine 106 to the outlet side of the turbine 108. The flow of the engine exhaust gases may cause the turbine 106 to rotate. As the turbine 106 rotates, it drives the compressor 100 that is connected to the turbine 106 through the common shaft 110. The rotating compressor 100 compresses the air to a higher pressure (boost pressure). The compressed air may help the engine develop increased power during combustion, and may also produce increased braking effect during engine braking.

An aftercooler (not shown) may be provided at any location between the outlet side of the compressor 100 and the intake manifold 220. The turbocharger, may be, but is not limited to, a fixed geometry turbocharger (FGT), variable geometry turbocharger (VGT), swing-vane type VGT, sliding-vane type VGT and/or any system or device that serves as a turbocharger.

To control the speed of the turbocharger, and hence the amount of pressure in the engine cylinders, the turbocharger may include a waste gate 130. The waste gate 130 may be disposed in an exhaust bypass line 120 extending between the exhaust manifold 320 and the turbocharger turbine outlet side 108. The waste gate 130 may be opened or actuated to divert a portion of the exhaust gas around the turbine 106 to reduce the rotational speed of the turbine 106 and the compressor 100. The waste gate 130 may be maintained or biased into a closed position, and actuated to permit a portion of the exhaust gas flowing from the exhaust manifold 320 to bypass the turbine 106, thus, reducing the rotational speed of the turbine 106 and compressor 100.

The waste gate 130 may be selectively opened under the control of a waste gate actuator 140. The waste gate actuator 140 may include an actuator plunger 142 operatively connected to the waste gate 130. The actuator plunger 142 may be biased by a spring 144 in a position that maintains the waste gate 130 closed. A waste gate actuator passage 170 may extend from the compressor outlet side 104 or the intake manifold 220 to the plunger 142 of the waste gate actuator 140. Air pressure from the intake manifold 220 may be applied through the waste gate actuator passage 170 to the plunger 142. If the pressure in the waste gate actuator passage 170 exceeds a predetermined level, the plunger 142 may be moved against the bias of the spring 144 to open the waste gate 130.

During engine braking, boost pressure may be desired to maximize the braking power of the engine. However, the strong pressure pulse created during compression-release type engine braking may cause the actuator 140 to open the waste gate 130, thereby reducing the rotational speed of the turbine 106. The reduced rotational speed of the turbine 106 may, in turn, reduce the rotational speed of the compressor 100, thereby reducing the boost pressure that is developed by the compressor and reducing the overall braking power generated by the engine.

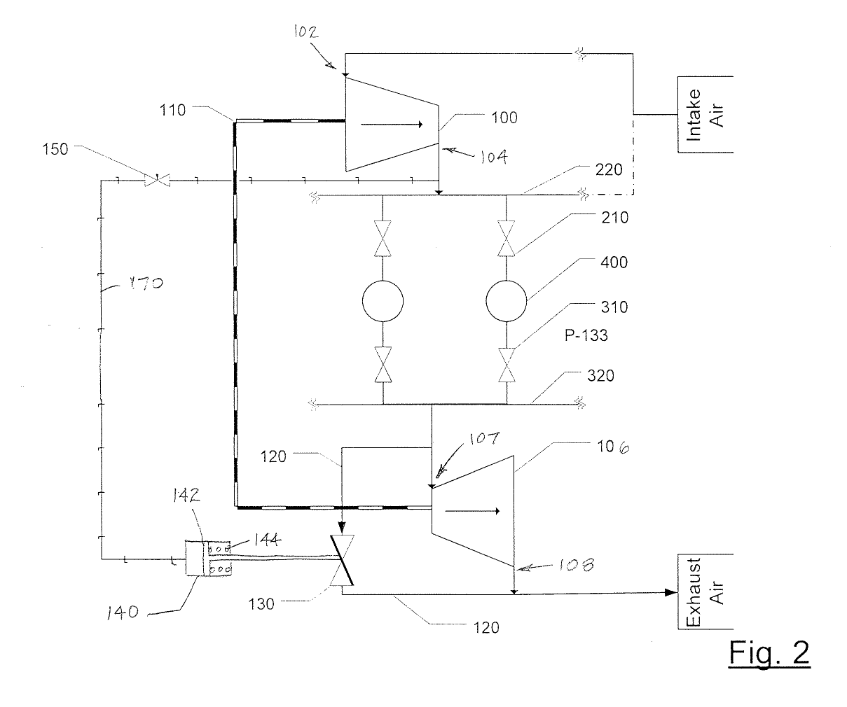

A first embodiment of the present invention is illustrated in FIG. 2, in which like reference characters refer to like elements to those shown in FIG. 1. With reference to FIG. 2, a waste gate actuator cut-off valve 150 may be disposed in the waste gate actuator passage 170. The cut-off valve 150 is capable of selectively restricting air flow through the waste gate actuator passage 170 by completely or partially blocking the waste gate actuator passage under the control of an electrical controller, such as an engine control module.

The system shown in FIG. 2 may deactivate the waste gate actuator 140 to ensure that the waste gate 130 may be maintained in a closed position during compression-release type engine braking and to ensure that the boost pressure that is required during compression-release type engine braking is not lost. The cut-off valve 150 may be provided by an air solenoid valve installed between the compressor 100 and the waste gate actuator 140. The cut-off valve 150 may block the connection between the compressor 100 and the waste gate actuator 140 during, part or all of, compression-release type engine braking. When the cut-off valve 150 is activated (i.e., closed) it may prevent the strong pressure pulse from activating the waste gate actuator 140, and opening the waste gate valve 130. Thus, activation of the cut-off valve 150 may prevent loss of boost pressure for the compression-release type engine braking event.

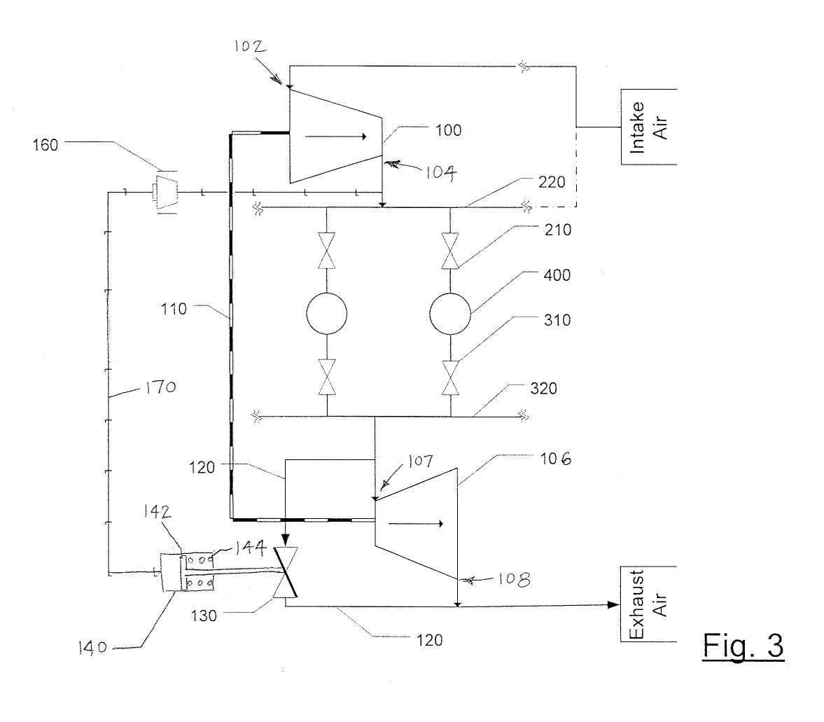

FIG. 3 discloses an alternate embodiment of the present invention restricting air flow to or the application of pressure on the waste gate actuator 140 to ensure that the waste gate 130 may be maintained in a closed position during compression-release type engine braking. In FIG. 3, a snubber 160 may be installed in the connection between the compressor 100 and the waste gate actuator 140. The snubber 160 may restrict flow of air between the compressor 100 and the waste gate actuator 140 during, part or all of, compression-release type engine braking. During compression-release type engine braking, the snubber 160 may damp the strong pressure pulse created by the compressor 100, thereby, preventing the activation of the waste gate actuator 140 during compression-release type engine braking.

It will be apparent to those skilled in the art that variations and modifications of the present invention can be made without departing from the scope or spirit of the invention. For example, the arrangement of the cut-off valve 150, as shown in FIG. 2 is for exemplary purposes only. Thus, it is intended that the present invention cover all such modifications and variations of the invention, provided they come within the scope of the appended claims and their equivalents.

What is claimed is:

1. A turbocharger system comprising:
a turbocharger turbine connected by a shaft to a turbocharger compressor, said turbocharger turbine having an inlet side and an outlet side, and said turbocharger compressor having an inlet side and an outlet side;
an exhaust manifold connected to the turbocharger turbine inlet side;
an intake manifold connected to the turbocharger compressor outlet side;
an exhaust bypass line extending between the exhaust manifold and the turbocharger turbine outlet side;
a waste gate disposed in the exhaust bypass line;
a waste gate actuator for controlling the opening and closing of the waste gate, said waste gate actuator operatively connected to the waste gate;
a waste gate actuator passage extending from the turbocharger compressor outlet side to the waste gate actuator; and
a means for restricting air flow through the waste gate actuator passage, said means for restricting disposed in the waste gate actuator passage.

2. The system of claim 1, wherein the means for restricting is a waste gate actuator passage cut-off valve.

3. The system of claim 2 further comprising:
means for controlling the waste gate actuator cut-off valve to block the waste gate actuator passage in response to engine braking in an engine including the turbocharger system.

4. The system of claim 3 wherein the waste gate actuator further comprises:
a pneumatic plunger operatively connected to the waste gate; and
means for biasing the pneumatic plunger into a position associated with the waste gate being in a closed position.

5. The system of claim 2 further comprising:
means for controlling the waste gate actuator cut-off valve to block the waste gate actuator passage.

6. The system of claim 1, wherein the means for restricting is a snubber.

7. A turbocharger system comprising:
a turbocharger turbine connected by a shaft to a turbocharger compressor, said turbocharger turbine having an inlet side and an outlet side, and said turbocharger compressor having an inlet side and an outlet side;
an exhaust manifold connected to the turbocharger turbine inlet side; an intake manifold connected to the turbocharger compressor outlet side;
an exhaust bypass line extending between the exhaust manifold and the turbocharger turbine outlet side;
a waste gate disposed in the exhaust bypass line;
a waste gate actuator for controlling the opening and closing of the waste gate, said waste gate actuator operatively connected to the waste gate;
a waste gate actuator passage extending from the turbocharger compressor outlet side to the waste gate actuator; and
a waste gate actuator cut-off valve disposed in the waste gate actuator passage.

8. The system of claim 7 further comprising:
means for controlling the waste gate actuator cut-off valve to block the waste gate actuator passage.

9. The system of claim 7 further comprising:
means for controlling the waste gate actuator cut-off valve to block the waste gate actuator passage in response to engine braking in an engine including the turbocharger system.

10. The system of claim 7 wherein the waste gate actuator cut-off valve selectively blocks the application of pneumatic pressure on the waste gate actuator.

11. The system of claim 7 wherein the waste gate actuator further comprises:
a pneumatic plunger operatively connected to the waste gate; and
means for biasing the pneumatic plunger into a position associated with the waste gate being in a closed position.

12. The system of claim 11 further comprising:
means for controlling the waste gate actuator cut-off valve to block the waste gate actuator passage.

13. The system of claim 11 wherein the means for controlling the waste gate actuator cut-off valve selectively blocks the waste gate actuator passage in response to engine braking in an engine including the turbocharger system.

14. A turbocharger system comprising:
a turbocharger turbine connected by a shaft to a turbocharger compressor, said turbocharger turbine having an inlet side and an outlet side, and said turbocharger compressor having an inlet side and an outlet side;
an exhaust manifold connected to the turbocharger turbine inlet side;
an intake manifold connected to the turbocharger compressor outlet side;
an exhaust bypass line extending between the exhaust manifold and the turbocharger turbine outlet side;
a waste gate disposed in the exhaust bypass line;
a waste gate actuator for controlling the opening and closing of the waste gate, said waste gate actuator operatively connected to the waste gate;
a waste gate actuator passage extending from the turbocharger compressor outlet side to the waste gate actuator; and
a snubber disposed in the waste gate actuator passage.
